(19) United States
(12) Patent Application Publication
(10) Pub. No.: US 2013/0240594 A1
(43) Pub. Date: Sep. 19, 2013

(54) CORDLESS CARTON CLOSER

(71) Applicant: STANLEY FASTENING SYSTEMS, L.P., North Kingstown, RI (US)

(72) Inventor: Gianpaolo Scabin, Lissone (IT)

(73) Assignee: STANLEY FASTENING SYSTEMS, L.P., North Kingstown, RI (US)

(21) Appl. No.: 13/803,760

(22) Filed: Mar. 14, 2013

Related U.S. Application Data
(60) Provisional application No. 61/612,649, filed on Mar. 19, 2012.

(51) Int. Cl. B25C 5/02

(52) U.S. Cl. CPC B25C 5/0207; B25C 5/0285
USPC 227/108; 227/144

(57) ABSTRACT

A fastener driving tool includes a housing, a drive track within the housing, a magazine connected to the housing and configured to hold a supply of fasteners and to provide a leading fastener to the drive track, a driver configured to move downward in the drive track and drive the leading fastener into a workpiece during a drive stroke, and upward in the drive track during a return stroke, a mount operatively connected to the driver, a power source at least partially contained within the housing and configured to provide power to the driver to move the driver during the drive stroke and the return stroke, and a clincher operatively connected to the housing and the driver, the clincher being configured to engage the leading fastener during the drive stroke and move into a clinching position at the end of the drive stroke to clinch the fastener to the workpiece.

### CROSS-REFERENCE TO RELATED APPLICATIONS

This application claims the benefit of priority from U.S. Provisional Patent Application Ser. No. 61/612,649, filed Mar. 19, 2012, the entire content of which is incorporated herein by reference.

### FIELD

This invention relates to fastener driving devices and more particularly to power operated portable fastener driving tools of the type including clinching mechanisms.

### BACKGROUND

Power operated portable fastener driving tools are used in industrial applications. For industrial applications, compressed air provides a convenient power source. Because of the nature of the compressed air power source and the expense involved in such heavy duty industrial fastener driving tools, they are generally not suitable for such use in various fastening jobs where maneuvering is required, space is limited, or compressed air is not available. As an alternative, manual fastening tools have been used. However, in many of the jobs where manual fasteners are used, considerable operator fatigue may be involved.

### SUMMARY

As an alternative to these challenges, electrically operated fastener driving tool can be used. An electrically operated tool avoids the inconvenience of the compressed air power source of the power operated tools for industrial uses. An electrically operated tool can use the electrical energization of a motor or solenoid to accomplish the driving action. Such a tool can be used commercially in situations where it would constitute an inconvenience to provide compressed air or fatigue-inducing a manual labor as sources of power.

It is desirable to provide a cordless fastener driving tool for sealing closed containers such as, for example, corrugated fiberboard cartons, by applying staples to the folded flaps or other closure parts to secure them in place.

Accordingly, embodiments of the present invention include a cordless electric fastener driving tool powered by a motor or a solenoid which obviates the disadvantages noted above. Thus, the fastener driving tool can function in the above-mentioned applications where prior art devices provided interference, as well as all of the other applications to which the prior art devices could be used.

In accordance with an aspect of the invention, there is provided a fastener driving tool that includes a housing, a drive track within the housing, a magazine connected to the housing and configured to hold a supply of fasteners and to provide a leading fastener to the drive track, a driver configured to move downward in the drive track and drive the leading fastener into a workpiece during a drive stroke, and upward in the drive track during a return stroke, a mount operatively connected to the driver, a power source at least partially contained within the housing and configured to provide power to the driver to move the driver during the drive stroke and the return stroke, and a clincher operatively connected to the housing and the driver, the clincher being configured to engage the leading fastener during the drive stroke and move into a clinching position at the end of the drive stroke to clinch the fastener to the workpiece.

In an embodiment, the clincher includes a first link pivotably connected to the mount and a second link pivotably connected to the mount; a first clincher arm pivotably connected to the first link and pivotably connected to the housing, and a second clincher arm pivotably connected to the second link and pivotably connected to the housing; and a first clincher anvil connected to the first clincher arm at a first end thereof, and a second clincher anvil connected to the second clincher arm at a first end thereof. A second end of the first clincher anvil and a second end of the second clincher anvil are each configured to move downwardly and inwardly towards each other to engage the leading fastener during the drive stroke and clinch the leading fastener to the workpiece at the end of the drive stroke.

In an embodiment, the fasteners are staples, wherein each staple comprises a crown and two legs extending from the crown. The driver is configured to engage the crown and each of the second ends of the first and second clincher anvils is configured to engage one of the legs.

In an embodiment, the first clincher anvil is integral with the first clincher arm, and the second clincher anvil is integral with the second clincher arm.

In an embodiment, the first clincher anvil and the second clincher anvil each have an arcuate shape and extend arcuately dowwardly from the respective second ends of the first clincher arm and the second clincher arm.

In an embodiment, a distal tip of the first clincher anvil and a distal tip of the second clincher anvil are each configured to pierce through the workpiece as the first clincher anvil and the second clincher anvil move downwardly and inwardly into the clinching position.

In an embodiment, the workpiece is a corrugated fiberboard container.

In an embodiment, the mount is integral with the driver.

In an embodiment, the power source comprises a solenoid assembly. The solenoid assembly comprises a solenoid and a plunger operatively connected to the driver. Linear movement of the plunger translates to linear movement of the driver.

In an embodiment, the power source includes a motor having a rotatable output shaft and a transmission operatively connected to the driver. Rotary movement of the rotatable output shaft translates to linear movement of the driver.

In an embodiment, the fastener driving tool includes a trigger mechanically coupled to a handle portion of the housing and electrically coupled to the motor such that the trigger selectively provides electric power to the motor when a user of the fastener driving tool operates the trigger while holding the handle portion.

In an embodiment, the fastener driving tool includes a trigger moveably mounted to the housing and operatively connected to the power source. The trigger is configured to initiate the drive stroke when actuated by a user of the fastener driving tool.

In an embodiment, the housing includes a handle portion configured to be gripped by a hand of the user and the trigger is moveably mounted to the housing in a location near the handle portion.

According to an aspect of the invention, there is provided a clinching assembly for a fastener driving tool. The fastener driving tool includes a housing, a drive track within the housing, a driver configured to move downward in the drive track to drive a fastener into a workpiece during a drive stroke, and upward in the drive track during a return stroke, and a mount operatively connected to the driver. The clinching assembly includes a first link pivotably connectable to the mount, and a second link pivotably connectable to the mount; a first clincher arm pivotably connected to the first link and pivotably connectable to the housing, and a second clincher arm pivotably connected to the second link and pivotably connectable to the housing; and a first clincher anvil connected to the first clincher arm at a first end thereof, and a second clincher anvil connected to the second clincher arm at a first end thereof. A second end of the first clincher anvil and a second end of the second clincher anvil are each configured to move downwardly and inwardly towards each other to engage the fastener during the drive stroke and clinch the fastener to the workpiece at the end of the drive stroke.

Further areas of applicability will become apparent from the description provided herein. It should be understood that the description and specific examples in this summary are intended for purposes of illustration only and are not intended to limit the scope of the present disclosure, its application and/or uses in any way.

### BRIEF DESCRIPTION OF THE DRAWINGS

The numerous advantages of the present invention may be better understood by those skilled in the art by reference to the accompanying figures. In the drawings, like reference numerals designate corresponding parts throughout the several views.

FIG. 1 illustrates an exemplary electrical fastening tool constructed in accordance with the teachings of the present disclosure;

FIG. 2 illustrates the fastener driving mechanism of the embodiment of FIG. 3;

FIG. 3 illustrates the fastener closing mechanism of an embodiment of the fastening tool;

FIGS. 4A-4C illustrate the fastener closing mechanism operation;

FIG. 5 illustrates another embodiment of the fastening tool positioned on top of a workpiece;

FIG. 6 illustrates the fastener driving mechanism of the embodiment of FIG. 5.

FIG. 7 is a sectional view of the fastener driving mechanism of the embodiment of FIG. 5;

FIG. 8 illustrates another view of the fastener driving mechanism of the embodiment of FIG. 5; and

FIG. 9 illustrates the fastener closing mechanism of the embodiment of FIG. 5.

### DETAILED DESCRIPTION

Reference will now be made in detail to the presently preferred embodiments of the invention, examples of which are illustrated in the accompanying drawings.

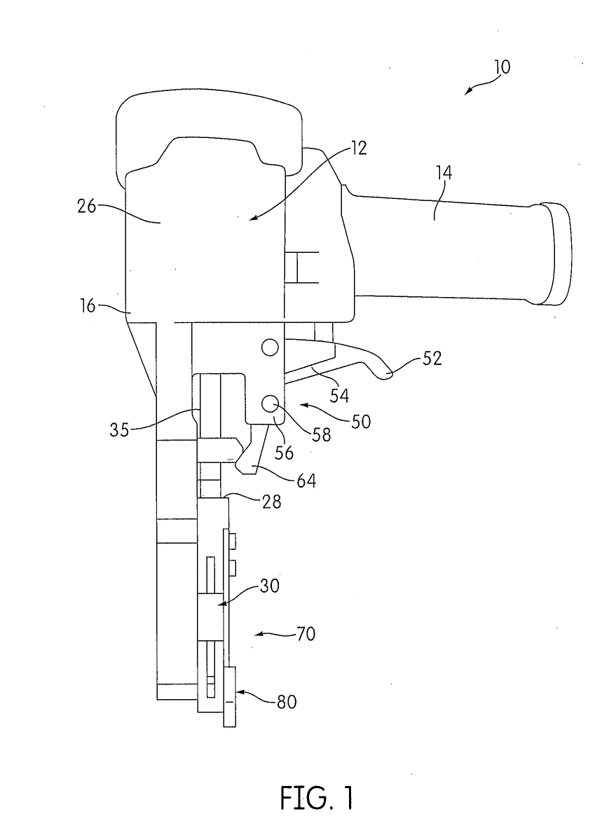

Referring now more particularly to the drawings, there is shown in FIG. 1 a vertical right side view of a fastener driving tool, generally indicated at 10, which embodies the principles of the present invention. As shown, the tool is an electrically actuated portable type tool capable of driving staples and clinching the same into work pieces, such as carton flaps and the like, the staples being, carried as a supply within the tool in the form of elongated preformed staples interconnected together in parallel relation and formed linearly within a magazine or in a coil form in a coil magazine.

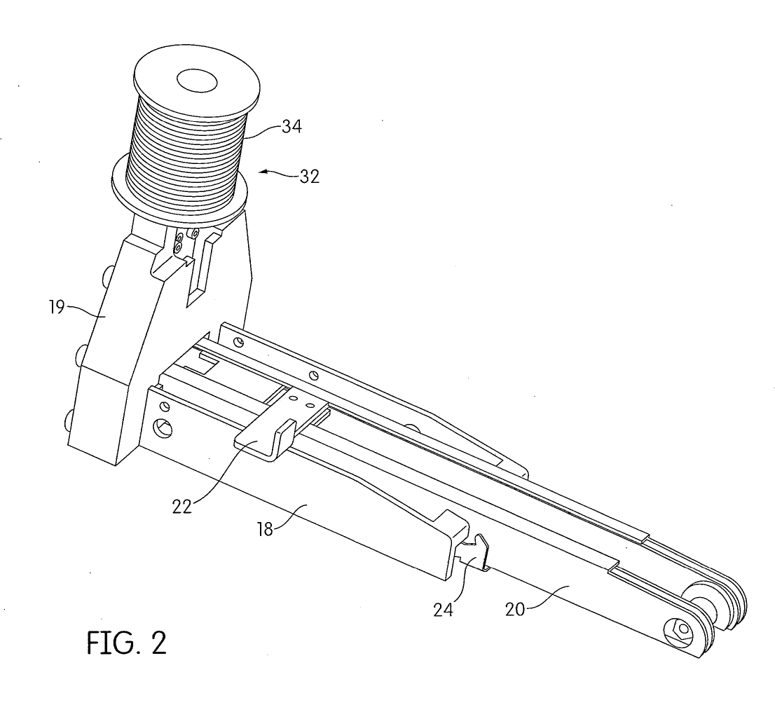

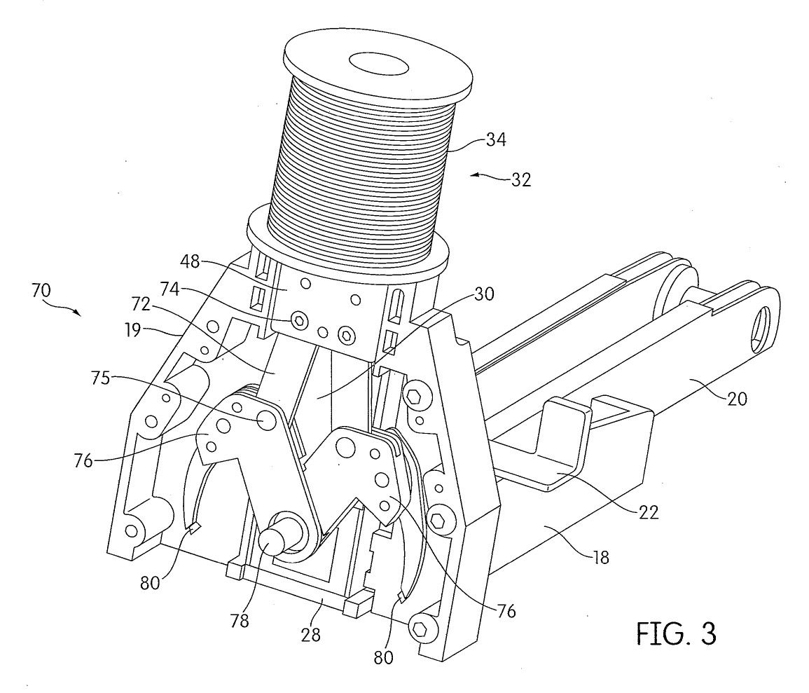

As shown in FIG. 1, the tool 10 includes a main casting or housing, generally indicated at 12, which provides a handle portion 14 adapted to be gripped by the hand of an operator, a vertical section 16 extending forwardly and downwardly from the forward end of the handle 14. The housing 12 can be integral with a base 18 (e.g. FIG. 2) and formed in a single casting. Alternatively, the housing 12 and the base 18 can be separately cast and the housing mounted onto the base. The housing and base unit include a magazine 20 for storing and arranging staples for delivery to a fastener or staple driving element (i.e. driver) 30. The magazine can be an elongated member as shown in FIGS. 2-3 in which staples are arranged linearly in parallel. Alternatively, the staples can be arranged in a coil for a more compact tool. The magazine includes a pusher 22 for pushing staples from an insertion end of the tool to a delivery end of the tool where the staples can be driven by the staple driver 30 and embedded into a workpiece W. The magazine 20 can be coupled to a flange portion 19 of the base housing the staple driver. The magazine also includes a magazine release lever 24 to disconnect the magazine from the tool when a staple is jammed in the tool.

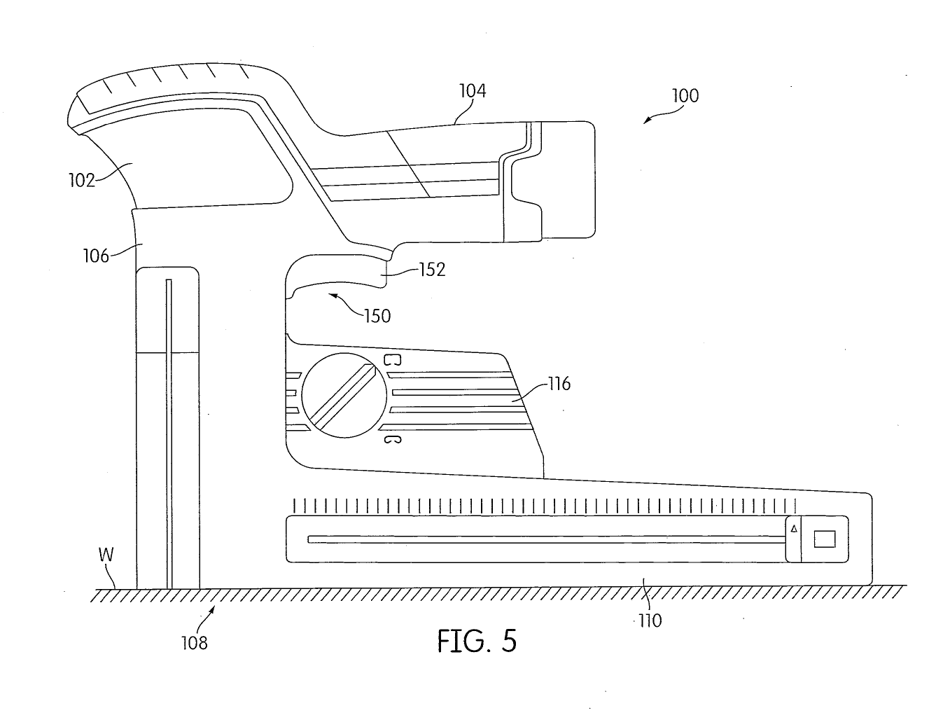

In one embodiment, the upper end portion of the forward section of the housing defines a solenoid housing or casing 26 including a solenoid serving as a power source for the tool. In another embodiment, shown in FIGS. 5-9, a motor serves as the power source for the tool.

Provided at the lower portion of the vertical housing section 16 is a fastener drive track 28 within which is mounted the staple driver 30. Staple driver 30 is moved through successive operating cycles, each of which includes a downward drive stroke and an upward return stroke.

For the purpose of effecting the movement of the staple driver 30 through successive operative cycles of movement, there is provided an electrical solenoid assembly, generally indicated at 32, which is carried by the housing structure 12 on the base 18 in a position forwardly of the handle 14 and rearwardly and above the front wall 16 and drive track 28. Preferably, the solenoid assembly constitutes a separately packaged sub-assembly within a casing (not shown). A solenoid coil 34 is mounted within the main body portion of the casing. Mounted within the coil 34 is a plunger or armature 35 including a lower portion of suitable dielectric material. The upper portion of the plunger 35 is constituted by a piston (not shown) of suitable ferro-magnetic material which is guided by sliding movement through a closure wall (not shown) formed as a part of the solenoid casing. The piston is adapted to engage a bumper stop (not shown) for the purpose of determining the upper limiting position of the plunger structure 35. The guiding movement provided by the piston slidably supported within the wall together with the sliding movement of the lower end portion of the plunger 35 provides for successive reciprocating cycles of movement of the solenoid plunger structure 35 along an axis of the drive stroke.

The staple driver 30 is connected with the lower end of the solenoid plunger or armature 35 of the solenoid assembly 32 through a driver mounting block, generally indicated at 48, which may also be referred to as a mount. In an embodiment, the mount 48 may be integral with the staple driver 30. As a result, the solenoid coil 34 acts as a linear actuator for actuating the staple driver 30 through a drive stroke in the drive track 28.

The solenoid assembly 34 is manually actuated by a manual actuating mechanism, generally indicated at 50, in FIG. 1, which is operable to activate and deactivate the solenoid coil 34 in response to the completion of the drive stroke of the solenoid plunger 35.

As best shown in FIG. 1, the manual actuating mechanism 50 includes a trigger member 52 moveably mounted to the housing 12 in a location near the handle portion 14 and is adapted to be digitally engaged by a user or operator grasping the housing handle portion 14 with a hand. The trigger member 52 has a pair of legs 54. The upper forward ends of the legs are pivoted to a pair of spaced depending bracket portions 56 forming a part of the main casting or housing 12. Each leg 54 of the trigger member 52 is apertured to receive the end of a pivot pin forming bolt 58 threadedly engaged within the associated bracket position 56. The forward bight portion of the trigger 52 is cut out to form a space for receiving a coil spring. One end of the coil spring (not shown) is connected to the trigger and the opposite end is connected with a pin (not shown) which extends laterally from a control lever 64.

The control lever 64 is mounted on one of the bracket portions 56 by an adjusting mechanism, which provides for the adjustment of the pivotal axis of the control lever 64 with respect to the housing 12.

A clinching assembly, which may be referred to as a clincher and generally indicated at 70 in FIG. 1, is mounted proximal to the nose of the tool in a position to define the rearward lower portion of the drive track 28. The driver mounting block (i.e. mount) 48 also serves to mount the clinching assembly 70 at a position alongside the staple driver 30.

As shown in FIG. 3, the clincher 70 is connected to the mount 48 by a pair of links 72. The links 72 are pivotably connected to the mount 48 through a pair of pivot pins 74. The clincher 70 includes a pair of clincher arms 76, which are pivoted to the lower end of the vertical housing section 16 by a pivot member generally indicated at 78 and are further pivotable on the links 72 through pivot pins 75. Each clincher arm 76 has mounted on the outer end thereof an arcuate clincher anvil 80 which, when the clincher is disposed in its retracted position, as shown in FIG. 3, extends arcuately downwardly from the end of the associated arm 76. The clincher arms 76 may be formed with interior grooves to receive the ends of the legs of a staple being driven to guidingly move the legs inwardly to effect clinching thereof. Each clincher anvil 80 may be integral with its respective clincher arm 76. In order to accomplish the clinching action, the clincher anvils 80 are moved downwardly and inwardly along an arcuate path into a clinching position. This movement is accomplished in response to the downward movement of the mount 48 by means of the pair of links 72 pivoted at their upper ends to the mount 48, by the pivot pins 74, and at their lower ends to an upper intermediate portion of an associated clincher arm 76 as by a pivot pin 75.

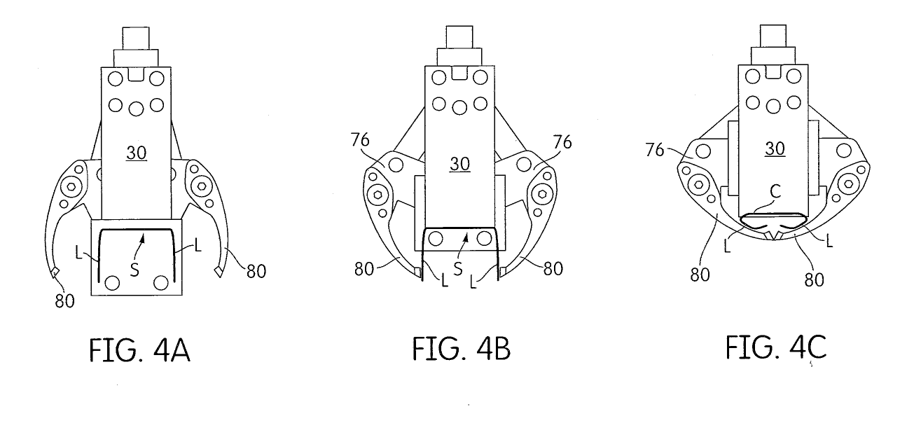

Referring now more particularly to FIGS. 4A-4C, the construction and operation of the clincher 70 of the embodiments of the present invention is shown therein.

With the tool 10 provided with a staple supply in the manner indicated above, the staples being formed in a U-shaped configuration; and with the leading staple S disposed within the drive track 28, it will be understood that when the operator actuates the trigger member 52, the solenoid plunger 35 will be moved through a drive stroke carrying with it the staple driver 30, and the clincher 70.

The solenoid, and also the motor assembly described and shown in FIGS. 5-9, provide a power source to the tool to operate the clincher assembly as shown in FIGS. 4A-4C. In FIG. 4A, the tool is in a resting state. The staple driver 30 is in a top position before the actuating mechanism or trigger 52 is engaged by a user of the tool 10. In this state, the clincher anvils 80 are in an open position. The leading staple S is in the magazine and connected to the remaining supply of staples. FIG. 4B illustrates the initial engagement of the trigger 52 which causes the staple driver 30 to move through the drive stroke. During the initial portion of the drive stroke, the lower end of the staple driver 30 engages the crown C of the staple S within the drive track 28 and moves the staple S downwardly. In addition, the clincher 70 is operated so that the clincher anvils 80 thereof are moved into a position to receive the free ends of the legs L of the staple S being driven as the latter move outwardly of the lower end of the drive track 28 and into the work piece. The clincher anvils 80 contact with the legs L of the leading staple S which has been pushed to the delivery end of the tool 10 by the pusher 22 of the magazine 20. At this stage, the legs L of the staple are being pushed into the workpiece. In FIG. 4C, the staple driver 30 is in a bottom position while the clincher anvils 80 are closed and fully pivoted toward each other in a clinching position, bending the legs L of the leading staple S toward each other. The clincher anvils 80 are also forced into the workpiece to press the legs of the leading staple toward each other. By the end of the drive stroke of the solenoid plunger 35, the legs of the driven staple are clinched on the clincher anvils 80 so that the staple S is clinched to the workpiece. As discussed herein, the clincher operation can also be driven by a motor assembly.

The body of the clincher arms can be metallic and formed from steel, for example. Alternatively, the body of the clincher arms can be titanium or any other rigid metal. Other materials that can be used to form the clincher arms include a rigid resin material, plastic or a composite material. Further, a combination of materials or material properties can be used for the clincher arms, as desired.

In another embodiment of the present invention, as shown in FIGS. 5-9, the power source for the fastener tool, generally indicated at 100, may be a motor assembly. FIG. 5 illustrates a vertical right side view of a fastener driving tool 100, which embodies the principles of the present invention. As shown, the tool 100 is an electrically actuated portable type tool having a motor assembly for driving the staple driver to deliver a staple into a workpiece W, such as carton flaps of a corrugated fiberboard container. The staples, although shown as being carried as a supply within the tool in the form of a linear magazine, may also be carried in a roll for a coil magazine for a more compact tool.

In accordance with the teachings of the present embodiment, the tool 100 includes a main casting or housing, generally indicated at 102, which provides a handle portion 104 adapted to be gripped by the hand of an operator, a vertical section 106 extending forwardly and downwardly from the forward end of the handle 104. The housing 102 can be mounted on or integral with a base section 108 that includes a magazine 110 for storing and arranging staples for delivery to a staple driver. The magazine 110 can be an elongated member as shown in FIGS. 5-9 in which staples are arranged linearly in parallel. The magazine 110 includes a pusher for pushing staples from an insertion end of the tool to a delivery end of the tool where the staples can be driven by the staple driver and embedded into a workpiece W. The magazine 110 also includes a magazine release lever 114 to disconnect the magazine from the tool when a staple is jammed in the tool.

As shown in FIGS. 5-7, the tool 100 also includes a motor housing 116, which can house a motor assembly 118, a transmission assembly 120 the staple driver 30 and a control module (not shown). The motor housing 116 can be arranged between the handle 104 and magazine 110, as shown in FIG. 5. Like elements have the same reference number as the same element in the embodiments herein.

The motor assembly includes a motor 122 that can drive the transmission 124, which in turn can actuate and advance the staple driver 30 to strike the crown C of the leading staple S shown in FIGS. 4A-4C.

Actuation of the staple driver 30 can drive staples which are sequentially fed from the magazine 110 into the clinching assembly 70 then into a workpiece W.

The motor 122 is actuated by the trigger assembly 150. The trigger assembly 150 includes a trigger member 152 that is mechanically coupled to handle 104 and electrically coupled to motor assembly 118 such that the trigger assembly selectively provides electric power to motor assembly when a user or operator of the tool 100 operates the trigger 152 while holding the handle portion 104. The motor assembly 118 includes a rotatable output shaft 119, which extends into the transmission assembly 120. A motor pinion 132 having a plurality of gear teeth is coupled for rotation with the output shaft 119.

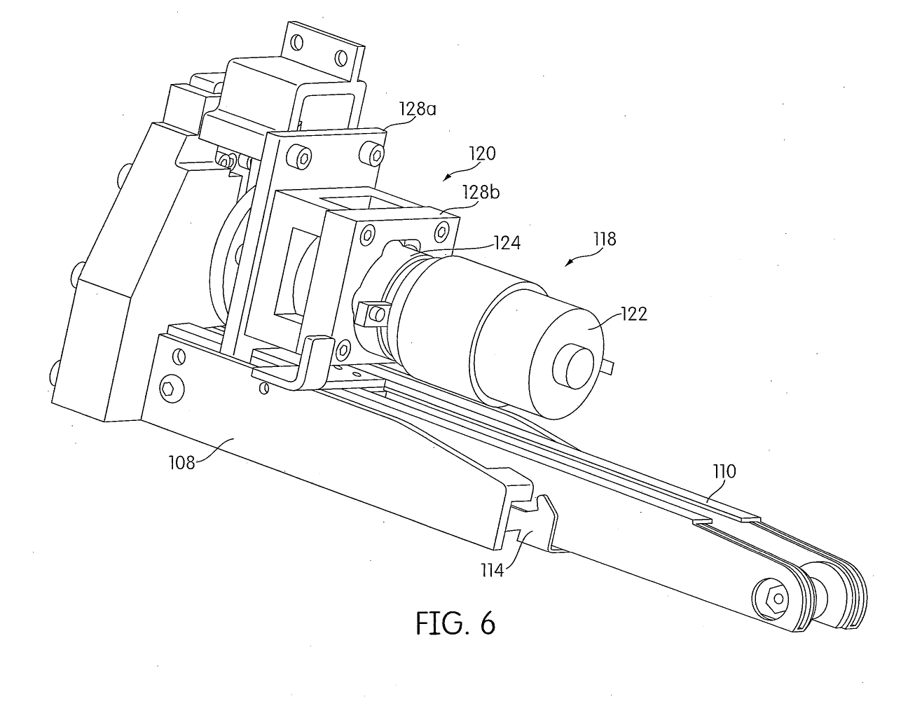

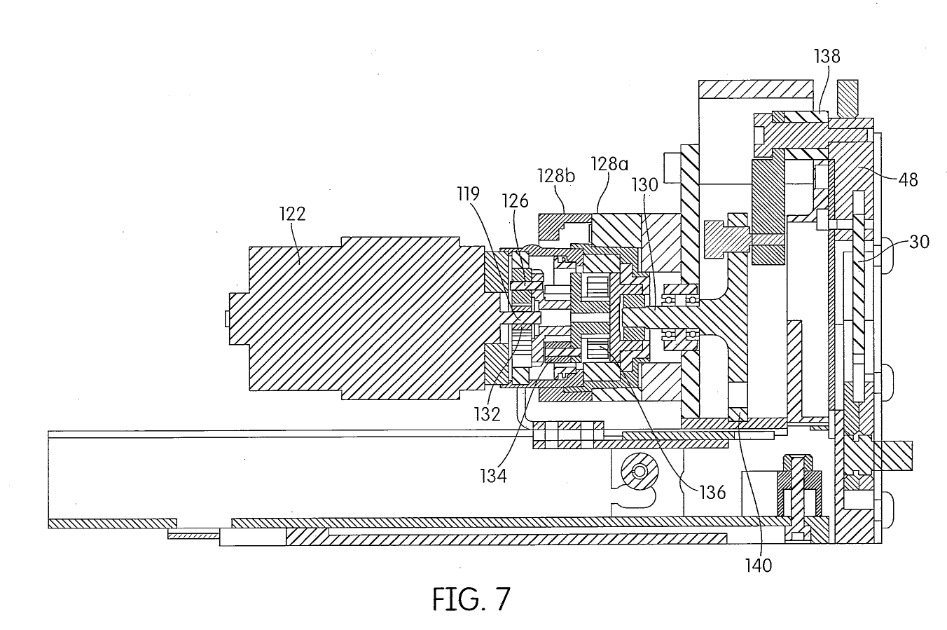

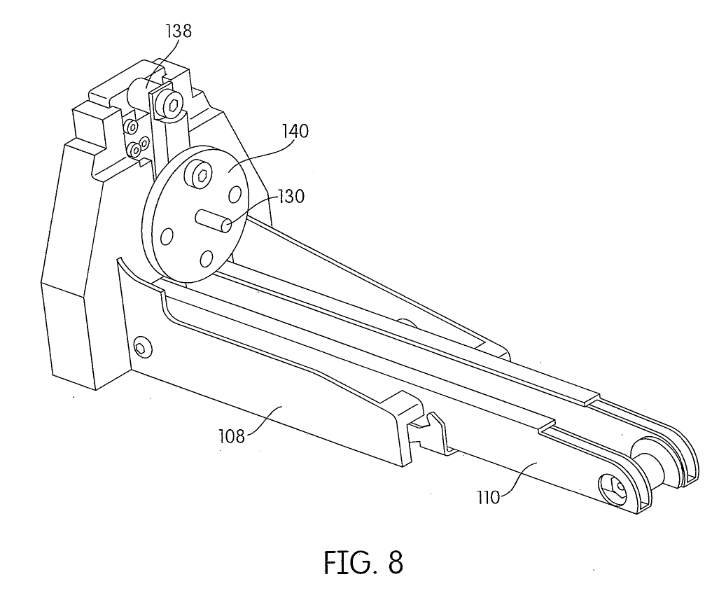

With reference to FIGS. 7 and 8, the output shaft 119 can connect an input or crankshaft 130 of the transmission assembly 120 to an output of the motor 122. A transmission housing such as the transmission mounting brackets 128a, 128b shown in FIG. 6, can encase the transmission assembly 120 a portion of a output shaft 119, and various other components of the transmission assembly. An output shaft bearing 126 can be employed to journally support the output shaft 119, in the transmission housing 128a, 128b. With reference to FIG. 7, the transmission assembly 120 can include a first drive gear 134, and a second drive gear 136 that can be coupled for rotation with the output shaft 119 within the transmission housing. The first drive gear 134 can be closer to the motor 122 relative to the second drive gear 136 The output shaft 119, the first drive gear 134, and the second drive gear 136, can rotate at the same rotational speed. The speed is controlled by the control module. The control module ensures that the transmission has enough rotations to ensure that enough momentum can be generated to drive the staple driver 30 into the workpiece W and to positively drive the staple driver in the downward drive stroke and the upward return stroke.

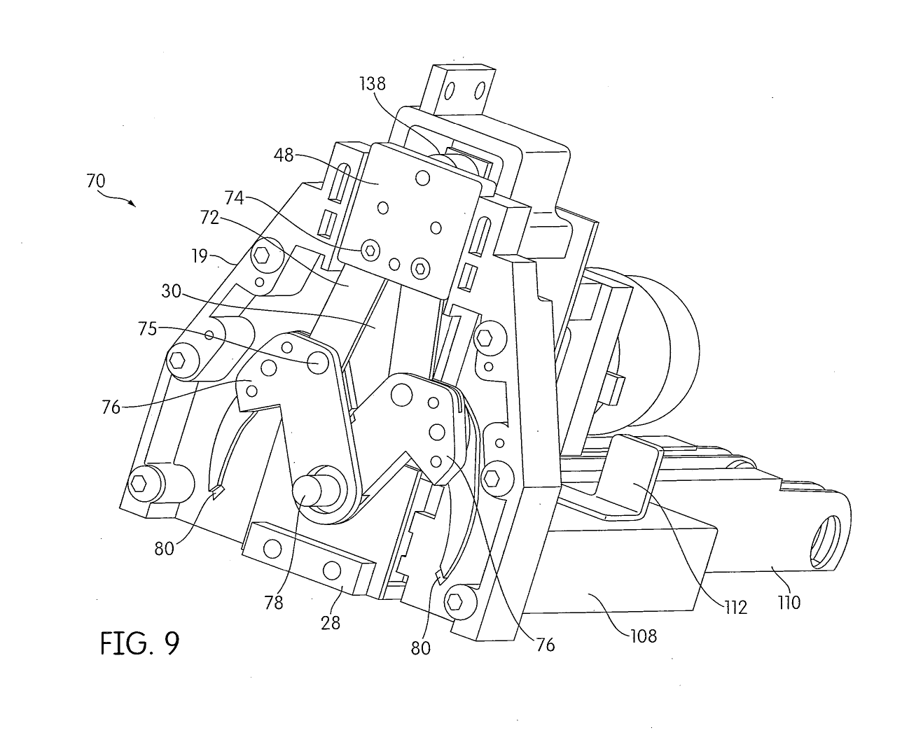

As shown in FIG. 9, a crank 140 of the transmission assembly is connected through a bushing 138 to the staple driver 30 to transmit the force from the transmission to the and effectuate the downward drive stroke. The operation of the clinching assembly through the downward, drive stroke is the same as that described above with respect to FIGS. 3 and 4.

While the fastener driving tool is illustrated as being cordless, those skilled in the art will appreciate that the invention, in its broader aspects, may be constructed somewhat differently and that aspects of the present invention may have applicability to other electrically powered driving tools, such as those powered by a battery pack or solar energy. In addition, to electronic powered tools, the tool can also be powered by gas-combustion, or hand-operated with a lower mechanical advantage.

Although staples are illustrated, the embodiments described herein include, but are not limited to, nails, brads, clips or any such suitable fastener that could be driven into and clinched to the workpiece W.

Furthermore, while aspects of the present invention are described herein and illustrated in the accompanying drawings in the context of a fastening tool, those of ordinary skill in the art will appreciate that the invention, in its broadest aspects, has further applicability.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, the mixing and matching of features, elements and/or functions between various examples is expressly contemplated herein, even if not specifically shown or described, so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims.

What is claimed is:

1. A fastener driving tool comprising:
a housing;
a drive track within the housing;
a magazine connected to the housing and configured to hold a supply of fasteners and to provide a leading fastener to the drive track;
a driver configured to move downward in the drive track and drive the leading fastener into a workpiece during a drive stroke, and upward in the drive track during a return stroke;
a mount operatively connected to the driver;
a power source at least partially contained within the housing and configured to provide power to the driver to move the driver during the drive stroke and the return stroke; and
a clincher operatively connected to the housing and the driver, the clincher being configured to engage the leading fastener during the drive stroke and move into a clinching position at the end of the drive stroke to clinch the fastener to the workpiece.

2. The fastener driving tool according to claim 1, wherein the clincher comprises:
a first link pivotably connected to the mount, and a second link pivotably connected to the mount;
a first clincher arm pivotably connected to the first link and pivotably connected to the housing, and a second clincher arm pivotably connected to the second link and pivotably connected to the housing; and
a first clincher anvil connected to the first clincher arm at a first end thereof, and a second clincher anvil connected to the second clincher arm at a first end thereof, wherein a second end of the first clincher anvil and a second end of the second clincher anvil are each configured to move downwardly and inwardly towards each other to engage the leading fastener during the drive stroke and clinch the leading fastener to the workpiece at the end of the drive stroke.

3. The fastener driving tool according to claim 2, wherein the fasteners are staples, wherein each staple comprises a crown and two legs extending from the crown, and wherein the driver is configured to engage the crown and each of the second ends of the first and second clincher anvils is configured to engage one of the legs.

4. The fastener driving tool according to claim 2, wherein the first clincher anvil is integral with the first clincher arm, and the second clincher anvil is integral with the second clincher arm.

5. The fastener driving tool according to claim 2, wherein the first clincher anvil and the second clincher anvil each have an arcuate shape and extend arcuately downwardly from the respective second ends of the first clincher arm and the second clincher arm.

6. The fastener driving tool according to claim 5, wherein a distal tip of the first clincher anvil and a distal tip of the second clincher anvil are each configured to pierce through the workpiece as the first clincher anvil and the second clincher anvil move downwardly and inwardly into the clinching position.

7. The fastener driving tool according to claim 6, wherein the workpiece is a corrugated fiberboard container.

8. The fastener driving tool according to claim 1, wherein the mount is integral with the driver.

9. The fastener driving tool according to claim 1, wherein the power source comprises a solenoid assembly, the solenoid assembly comprising a solenoid and a plunger operatively connected to the driver, and wherein linear movement of the plunger translates to linear movement of the driver.

10. The fastener driving tool according to claim 1, wherein the power source comprises a motor having a rotatable output shaft and a transmission operatively connected to the driver, and wherein rotary movement of the rotatable output shaft translates to linear movement of the driver.

11. The fastener driving tool according to claim 10, further comprising a trigger mechanically coupled to a handle portion of the housing and electrically coupled to the motor such that the trigger selectively provides electric power to the motor when a user of the fastener driving tool operates the trigger while holding the handle portion.

12. The fastener driving tool according to claim 1, further comprising a trigger moveably mounted to the housing and operatively connected to the power source, the trigger being configured to initiate the drive stroke when actuated by a user of the fastener driving tool.

13. The fastener driving tool according to claim 12, wherein the housing comprises a handle portion configured to be gripped by a hand of the user, the trigger being moveably mounted to the housing in a location near the handle portion.

14. A clinching assembly for a fastener driving tool, the fastener driving tool comprising a housing, a drive track within the housing, a driver configured to move downward in the drive track to drive a fastener into a workpiece during a drive stroke, and upward in the drive track during a return stroke, and a mount operatively connected to the driver, the clinching assembly comprising:
a first link pivotably connectable to the mount, and a second link pivotably connectable to the mount;
a first clincher arm pivotably connected to the first link and pivotably connectable to the housing, and a second clincher arm pivotably connected to the second link and pivotably connectable to the housing; and
a first clincher anvil connected to the first clincher arm at a first end thereof, and a second clincher anvil connected to the second clincher arm at a first end thereof, wherein a second end of the first clincher anvil and a second end of the second clincher anvil are each configured to move downwardly and inwardly towards each other to engage the fastener during the drive stroke and clinch the fastener to the workpiece at the end of the drive stroke.

15. The clinching assembly according to claim 14, wherein the first clincher anvil is integral with the first clincher arm, and the second clincher anvil is integral with the second clincher arm.

16. The clinching assembly according to claim 14, wherein the first clincher anvil and the second clincher anvil each have an arcuate shape and extend arcuately downwardly from the respective second ends of the first clincher arm and the second clincher arm.

17. The clinching assembly according to claim 16, wherein a distal tip of the first clincher anvil and a distal tip of the second clincher anvil are each configured to pierce through the workpiece as the first clincher anvil and the second clincher anvil move downwardly and inwardly to the clinching position.

18. The clinching assembly according to claim 17, wherein the workpiece is a corrugated fiberboard container.
